(19) United States
(12) Patent Application Publication
(10) Pub. No.: US 2020/0320524 A1
(43) Pub. Date: Oct. 8, 2020

(54) System, Method, and Computer Program Product for Anonymizing Transactions

(71) Applicant: Visa International Service Association, San Francisco, CA (US)

(72) Inventor: Gurpreet Singh Bhasin, Fremont, CA (US)

(21) Appl. No.: 16/373,887

(22) Filed: Apr. 3, 2019

(51) Int. Cl. G06Q 20/38; G06Q 20/40; G06Q 20/32; H04L 9/32

(52) U.S. Cl. CPC G06Q 20/383; G06Q 20/4014; G06Q 2220/00; G06Q 20/3223; H04L 9/3213; G06Q 20/3226

(57) ABSTRACT

Provided is a system, method, and computer program product for anonymizing a plurality of transactions. The method includes receiving a plurality of transaction requests from a plurality of account holders, each transaction request comprising a payee identifier and a payer identifier, generating a plurality of anonymous authorization requests corresponding to the plurality of transaction requests, communicating the plurality of anonymous authorization requests to at least one issuer system or a transaction processing system, receiving a plurality of authorization responses corresponding to the plurality of anonymous authorization requests, determining that a first plurality of transaction requests of the plurality of transaction requests satisfies a threshold, generating a plurality of anonymous payment tokens, each anonymous payment token corresponding to an authorized transaction request of the first plurality of transaction requests, and allocating each anonymous payment token to a corresponding payee identifier.

### BACKGROUND

### 1. Field

This disclosure relates generally to conducting transactions, in non-limiting embodiments, to a system, method, and computer program product for anonymizing a plurality of transactions.

### 2. Technical Considerations

Existing payment systems create records that can be easily used to determine the identity of the payer and/or payee in a payment transaction. For example, to conduct a payment transaction using a credit card, the account holder's financial institution must be exposed to the identity of both the account holder and the payee. Similarly, the payee is exposed to the identity of the payer through the transaction. This exchange of information raises privacy concerns and allows financial institutions, merchants, and other parties to target advertisements and otherwise commercialize users' purchase data.

The ability to anonymize such transactions is limited to obscuring the payer information through the use of a third-party. However, the transaction records created from such transactions are easily combined to infer the identity of the payee and payer due to the temporal association between corresponding transactions. There is a need for a system, method, and computer program product for anonymizing a plurality of transactions that overcomes some or all of these problems.

### SUMMARY

According to non-limiting embodiments or aspects, provided is a computer-implemented method for anonymizing a plurality of transactions, comprising: receiving, with at least one processor, a plurality of transaction requests from a plurality of account holders, each transaction request comprising a payee identifier and a payer identifier; generating, with at least one processor, a plurality of anonymous authorization requests corresponding to the plurality of transaction requests, wherein each anonymous authorization request is independent of the payee identifier of the corresponding transaction request; communicating, with at least one processor, the plurality of anonymous authorization requests to at least one issuer system or a transaction processing system; receiving, with at least one processor, a plurality of authorization responses corresponding to the plurality of anonymous authorization requests; determining, with at least one processor, that a first plurality of transaction requests of the plurality of transaction requests satisfies a threshold; in response to determining that the first plurality of transaction requests satisfies the threshold, generating, with at least one processor, a plurality of anonymous payment tokens, each anonymous payment token corresponding to an authorized transaction request of the first plurality of transaction requests; and allocating, with at least one processor, each anonymous payment token to a corresponding payee identifier. In non-limiting embodiments or aspects, further comprising: determining, with at least one processor, that a second plurality of authorized transaction requests of the plurality of transaction requests satisfies the threshold or a second threshold; in response to determining that the second plurality of authorized transaction requests satisfies the threshold, generating, with at least one processor, a second plurality of anonymous payment tokens, each anonymous payment token corresponding to an authorized transaction request of the second plurality of authorized transaction requests; and allocating, with at least one processor, each anonymous payment token to a corresponding payee identifier.

In non-limiting embodiments or aspects, the threshold comprises at least one of the following: a number of transactions, a number of accounts, an aggregate transaction value, or any combination thereof. In non-limiting embodiments or aspects, the threshold comprises at least one of the following: a random value, a dynamic value, a predetermined value, or any combination thereof. In non-limiting embodiments or aspects, the plurality of anonymous authorization requests correspond to the first plurality of transactions, and the plurality of anonymous authorization requests are communicated to the at least one issuer system or transaction processing system in response to determining that the first plurality of transactions satisfies the threshold. In non-limiting embodiments or aspects, the plurality of anonymous authorization requests correspond to the plurality of transactions, and the plurality of anonymous authorization requests are communicated to the at least one issuer system or transaction processing system prior to determining that the first plurality of transactions satisfies the threshold.

In non-limiting embodiments or aspects, the method further comprises: for each transaction request of the plurality of transaction requests, determine a pool from a plurality of pools to allocate the transaction request, the first plurality of transactions is allocated to a first pool; and for each pool of the plurality of pools, adding transaction values for each transaction request in the pool to determine an aggregate pool transaction value, the threshold is satisfied when the aggregate pool transaction value meets or exceeds the threshold. In non-limiting embodiments or aspects, the method further comprises: for each transaction request of the plurality of transaction requests, determine a pool from a plurality of pools to allocate the transaction request, the first plurality of transactions is allocated to a first pool; and for each pool of the plurality of pools, incrementing a counter for each transaction request in the pool to determine an aggregate number of transactions, the threshold is satisfied when the aggregate number of transactions meets or exceeds the threshold.

According to non-limiting embodiments or aspects, provided is a computer program product for anonymizing a plurality of transactions, comprising at least one non-transitory computer-readable medium including program instructions that, when executed by at least one processor, cause the at least one processor to: receive a plurality of transaction requests from a plurality of account holders, each transaction request comprising a payee identifier and a payer identifier; generate a plurality of anonymous authorization requests corresponding to the plurality of transaction requests, wherein each anonymous authorization request is independent of the payee identifier of the corresponding transaction request; communicate the plurality of anonymous authorization requests to at least one issuer system or a transaction processing system; receive a plurality of authorization responses corresponding to the plurality of anonymous authorization requests; determine that a first plurality of transaction requests of the plurality of transaction requests satisfies a threshold; in response to determining that the first plurality of transaction requests satisfies the threshold, generate a plurality of anonymous payment tokens, each anonymous payment token corresponding to an authorized transaction request of the first plurality of transaction requests; and allocate each anonymous payment token to a corresponding payee identifier.

In non-limiting embodiments or aspects, the program instructions further cause the at least one processor to: determine that a second plurality of authorized transaction requests of the plurality of transaction requests satisfies the threshold or a second threshold; in response to determining that the second plurality of authorized transaction requests satisfies the threshold, generate a second plurality of anonymous payment tokens, each anonymous payment token corresponding to an authorized transaction request of the second plurality of authorized transaction requests; and allocate each anonymous payment token to a corresponding payee identifier. In non-limiting embodiments or aspects, the threshold comprises at least one of the following: a number of transactions, a number of accounts, an aggregate transaction value, or any combination thereof. In non-limiting embodiments or aspects, the threshold comprises at least one of the following: a random value, a dynamic value, a predetermined value, or any combination thereof. In non-limiting embodiments or aspects, the plurality of anonymous authorization requests correspond to the first plurality of transactions, and the plurality of anonymous authorization requests are communicated to the at least one issuer system or transaction processing system in response to determining that the first plurality of transactions satisfies the threshold. In non-limiting embodiments or aspects, the plurality of anonymous authorization requests correspond to the plurality of transactions, and the plurality of anonymous authorization requests are communicated to the at least one issuer system or transaction processing system prior to determining that the first plurality of transactions satisfies the threshold.

In non-limiting embodiments or aspects, the program instructions further cause the at least one processor to: for each transaction request of the plurality of transaction requests, determine a pool from a plurality of pools to allocate the transaction request, the first plurality of transactions is allocated to a first pool; and for each pool of the plurality of pools, add transaction values for each transaction request in the pool to determine an aggregate pool transaction value, the threshold is satisfied when the aggregate pool transaction value meets or exceeds the threshold. In non-limiting embodiments or aspects, the program instructions further cause the at least one processor to: for each transaction request of the plurality of transaction requests, determine a pool from a plurality of pools to allocate the transaction request, the first plurality of transactions is allocated to a first pool; and for each pool of the plurality of pools, increment a counter for each transaction request in the pool to determine an aggregate number of transactions, the threshold is satisfied when the aggregate number of transactions meets or exceeds the threshold.

According to non-limiting embodiments or aspects, provided is a system for anonymizing a plurality of transactions, comprising: at least one data storage device comprising a ledger for a plurality of payees; and at least one processor programmed or configured to: receive a plurality of transaction requests from a plurality of account holders, each transaction request comprising a payee identifier and a payer identifier; generate a plurality of anonymous authorization requests corresponding to the plurality of transaction requests, wherein each anonymous authorization request is independent of the payee identifier of the corresponding transaction request; communicate the plurality of anonymous authorization requests to at least one issuer system or a transaction processing system; receive a plurality of authorization responses corresponding to the plurality of anonymous authorization requests; determine that a first plurality of transaction requests of the plurality of transaction requests satisfies a threshold; in response to determining that the first plurality of transaction requests satisfies the threshold, generate a plurality of anonymous payment tokens, each anonymous payment token corresponding to an authorized transaction request of the first plurality of transaction requests; and allocate each anonymous payment token to a corresponding payee identifier.

In non-limiting embodiments or aspects, the at least one processor is further programmed or configured to: determine that a second plurality of authorized transaction requests of the plurality of transaction requests satisfies the threshold or a second threshold; in response to determining that the second plurality of authorized transaction requests satisfies the threshold, generate a second plurality of anonymous payment tokens, each anonymous payment token corresponding to an authorized transaction request of the second plurality of authorized transaction requests; and allocate each anonymous payment token to a corresponding payee identifier. In non-limiting embodiments or aspects, the threshold comprises at least one of the following: a number of transactions, a number of accounts, an aggregate transaction value, or any combination thereof. In non-limiting embodiments or aspects, the threshold comprises at least one of the following: a random value, a dynamic value, a predetermined value, or any combination thereof. In non-limiting embodiments or aspects, the plurality of anonymous authorization requests correspond to the first plurality of transactions, and the plurality of anonymous authorization requests are communicated to the at least one issuer system or transaction processing system in response to determining that the first plurality of transactions satisfies the threshold. In non-limiting embodiments or aspects, the plurality of anonymous authorization requests correspond to the plurality of transactions, and the plurality of anonymous authorization requests are communicated to the at least one issuer system or transaction processing system prior to determining that the first plurality of transactions satisfies the threshold.

In non-limiting embodiments or aspects, the processor is further programmed or configured to: for each transaction request of the plurality of transaction requests, determine a pool from a plurality of pools to allocate the transaction request, the first plurality of transactions is allocated to a first pool; and for each pool of the plurality of pools, add transaction values for each transaction request in the pool to determine an aggregate pool transaction value, the threshold is satisfied when the aggregate pool transaction value meets or exceeds the threshold. In non-limiting embodiments or aspects, the processor is further programmed or configured to: for each transaction request of the plurality of transaction requests, determine a pool from a plurality of pools to allocate the transaction request, the first plurality of transactions is allocated to a first pool; and for each pool of the plurality of pools, increment a counter for each transaction request in the pool to determine an aggregate number of transactions, the threshold is satisfied when the aggregate number of transactions meets or exceeds the threshold.

Further non-limiting embodiments or aspects are set forth in the following numbered clauses:

Clause 1: A computer-implemented method for anonymizing a plurality of transactions, comprising: receiving, with at least one processor, a plurality of transaction requests from a plurality of account holders, each transaction request comprising a payee identifier and a payer identifier; generating, with at least one processor, a plurality of anonymous authorization requests corresponding to the plurality of transaction requests, wherein each anonymous authorization request is independent of the payee identifier of the corresponding transaction request; communicating, with at least one processor, the plurality of anonymous authorization requests to at least one issuer system or a transaction processing system; receiving, with at least one processor, a plurality of authorization responses corresponding to the plurality of anonymous authorization requests; determining, with at least one processor, that a first plurality of transaction requests of the plurality of transaction requests satisfies a threshold; in response to determining that the first plurality of transaction requests satisfies the threshold, generating, with at least one processor, a plurality of anonymous payment tokens, each anonymous payment token corresponding to an authorized transaction request of the first plurality of transaction requests; and allocating, with at least one processor, each anonymous payment token to a corresponding payee identifier.

Clause 2: The computer-implemented method of clause 1, further comprising: determining, with at least one processor, that a second plurality of authorized transaction requests of the plurality of transaction requests satisfies the threshold or a second threshold; in response to determining that the second plurality of authorized transaction requests satisfies the threshold, generating, with at least one processor, a second plurality of anonymous payment tokens, each anonymous payment token corresponding to an authorized transaction request of the second plurality of authorized transaction requests; and allocating, with at least one processor, each anonymous payment token to a corresponding payee identifier.

Clause 3: The computer-implemented method of clauses 1 or 2, wherein the threshold comprises at least one of the following: a number of transactions, a number of accounts, an aggregate transaction value, or any combination thereof.

Clause 4: The computer-implemented method of any of clauses 1-3, wherein the threshold comprises at least one of the following: a random value, a dynamic value, a predetermined value, or any combination thereof.

Clause 5: The computer-implemented method of any of clauses 1-4, wherein the plurality of anonymous authorization requests correspond to the first plurality of transactions, and wherein the plurality of anonymous authorization requests are communicated to the at least one issuer system or transaction processing system in response to determining that the first plurality of transactions satisfies the threshold.

Clause 6: The computer-implemented method of any of clauses 1-5, wherein the plurality of anonymous authorization requests correspond to the plurality of transactions, and wherein the plurality of anonymous authorization requests are communicated to the at least one issuer system or transaction processing system prior to determining that the first plurality of transactions satisfies the threshold.

Clause 7: The computer-implemented method of any of clauses 1-6, further comprising: for each transaction request of the plurality of transaction requests, determine a pool from a plurality of pools to allocate the transaction request, wherein the first plurality of transactions is allocated to a first pool; and for each pool of the plurality of pools, adding transaction values for each transaction request in the pool to determine an aggregate pool transaction value, wherein the threshold is satisfied when the aggregate pool transaction value meets or exceeds the threshold.

Clause 8: The computer-implemented method of any of clauses 1-7, further comprising: for each transaction request of the plurality of transaction requests, determine a pool from a plurality of pools to allocate the transaction request, wherein the first plurality of transactions is allocated to a first pool; and for each pool of the plurality of pools, incrementing a counter for each transaction request in the pool to determine an aggregate number of transactions, wherein the threshold is satisfied when the aggregate number of transactions meets or exceeds the threshold.

Clause 9: A computer program product for anonymizing a plurality of transactions, comprising at least one non-transitory computer-readable medium including program instructions that, when executed by at least one processor, cause the at least one processor to: receive a plurality of transaction requests from a plurality of account holders, each transaction request comprising a payee identifier and a payer identifier; generate a plurality of anonymous authorization requests corresponding to the plurality of transaction requests, wherein each anonymous authorization request is independent of the payee identifier of the corresponding transaction request; communicate the plurality of anonymous authorization requests to at least one issuer system or a transaction processing system; receive a plurality of authorization responses corresponding to the plurality of anonymous authorization requests; determine that a first plurality of transaction requests of the plurality of transaction requests satisfies a threshold; in response to determining that the first plurality of transaction requests satisfies the threshold, generate a plurality of anonymous payment tokens, each anonymous payment token corresponding to an authorized transaction request of the first plurality of transaction requests; and allocate each anonymous payment token to a corresponding payee identifier.

Clause 10: The computer program product of clause 9, wherein the program instructions further cause the at least one processor to: determine that a second plurality of authorized transaction requests of the plurality of transaction requests satisfies the threshold or a second threshold; in response to determining that the second plurality of authorized transaction requests satisfies the threshold, generate a second plurality of anonymous payment tokens, each anonymous payment token corresponding to an authorized transaction request of the second plurality of authorized transaction requests; and allocate each anonymous payment token to a corresponding payee identifier.

Clause 11: The computer program product of clauses 9 or 10, wherein the threshold comprises at least one of the following: a number of transactions, a number of accounts, an aggregate transaction value, or any combination thereof.

Clause 12: The computer program product of any of clauses 9-11, wherein the threshold comprises at least one of the following: a random value, a dynamic value, a predetermined value, or any combination thereof.

Clause 13: The computer program product of any of clauses 9-12, wherein the plurality of anonymous authorization requests correspond to the first plurality of transactions, and wherein the plurality of anonymous authorization requests are communicated to the at least one issuer system or transaction processing system in response to determining that the first plurality of transactions satisfies the threshold.

Clause 14: The computer program product of any of clauses 9-13, wherein the plurality of anonymous authorization requests correspond to the plurality of transactions, and wherein the plurality of anonymous authorization requests are communicated to the at least one issuer system or transaction processing system prior to determining that the first plurality of transactions satisfies the threshold.

Clause 15: The computer program product of any of clauses 9-14, wherein the program instructions further cause the at least one processor to: for each transaction request of the plurality of transaction requests, determine a pool from a plurality of pools to allocate the transaction request, wherein the first plurality of transactions is allocated to a first pool; and for each pool of the plurality of pools, add transaction values for each transaction request in the pool to determine an aggregate pool transaction value, wherein the threshold is satisfied when the aggregate pool transaction value meets or exceeds the threshold.

Clause 16: The computer program product of any of clauses 9-15, wherein the program instructions further cause the at least one processor to: for each transaction request of the plurality of transaction requests, determine a pool from a plurality of pools to allocate the transaction request, wherein the first plurality of transactions is allocated to a first pool; and for each pool of the plurality of pools, increment a counter for each transaction request in the pool to determine an aggregate number of transactions, wherein the threshold is satisfied when the aggregate number of transactions meets or exceeds the threshold.

Clause 17: A system for anonymizing a plurality of transactions, comprising: at least one data storage device comprising a ledger for a plurality of payees; and at least one processor programmed or configured to: receive a plurality of transaction requests from a plurality of account holders, each transaction request comprising a payee identifier and a payer identifier; generate a plurality of anonymous authorization requests corresponding to the plurality of transaction requests, wherein each anonymous authorization request is independent of the payee identifier of the corresponding transaction request; communicate the plurality of anonymous authorization requests to at least one issuer system or a transaction processing system; receive a plurality of authorization responses corresponding to the plurality of anonymous authorization requests; determine that a first plurality of transaction requests of the plurality of transaction requests satisfies a threshold; in response to determining that the first plurality of transaction requests satisfies the threshold, generate a plurality of anonymous payment tokens, each anonymous payment token corresponding to an authorized transaction request of the first plurality of transaction requests; and allocate each anonymous payment token to a corresponding payee identifier.

Clause 18: The system of clause 17, wherein the at least one processor is further programmed or configured to: determine that a second plurality of authorized transaction requests of the plurality of transaction requests satisfies the threshold or a second threshold; in response to determining that the second plurality of authorized transaction requests satisfies the threshold, generate a second plurality of anonymous payment tokens, each anonymous payment token corresponding to an authorized transaction request of the second plurality of authorized transaction requests; and allocate each anonymous payment token to a corresponding payee identifier.

Clause 19: The system of clauses 17 or 18, wherein the threshold comprises at least one of the following: a number of transactions, a number of accounts, an aggregate transaction value, or any combination thereof.

Clause 20: The system of any of clauses 17-19, wherein the threshold comprises at least one of the following: a random value, a dynamic value, a predetermined value, or any combination thereof.

Clause 21: The system of any of clauses 17-20, wherein the plurality of anonymous authorization requests correspond to the first plurality of transactions, and wherein the plurality of anonymous authorization requests are communicated to the at least one issuer system or transaction processing system in response to determining that the first plurality of transactions satisfies the threshold.

Clause 22: The system of any of clauses 17-21, wherein the plurality of anonymous authorization requests correspond to the plurality of transactions, and wherein the plurality of anonymous authorization requests are communicated to the at least one issuer system or transaction processing system prior to determining that the first plurality of transactions satisfies the threshold.

Clause 23: The system of any of clauses 17-22, wherein the processor is further programmed or configured to: for each transaction request of the plurality of transaction requests, determine a pool from a plurality of pools to allocate the transaction request, wherein the first plurality of transactions is allocated to a first pool; and for each pool of the plurality of pools, add transaction values for each transaction request in the pool to determine an aggregate pool transaction value, wherein the threshold is satisfied when the aggregate pool transaction value meets or exceeds the threshold.

Clause 24: The system of any of clauses 17-23, wherein the processor is further programmed or configured to: for each transaction request of the plurality of transaction requests, determine a pool from a plurality of pools to allocate the transaction request, wherein the first plurality of transactions is allocated to a first pool; and for each pool of the plurality of pools, increment a counter for each transaction request in the pool to determine an aggregate number of transactions, wherein the threshold is satisfied when the aggregate number of transactions meets or exceeds the threshold.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments that are illustrated in the accompanying schematic figures, in which:

FIG. 1A is a schematic diagram of a system for anonymizing a plurality of transactions according to a non-limiting embodiment;

FIG. 1B is a schematic diagram of a system for anonymizing a plurality of transactions according to a non-limiting embodiment;

FIG. 2 is another schematic diagram of a system for anonymizing a plurality of transactions according to a non-limiting embodiment;

FIG. 3 is a sequence diagram of a method for anonymizing a plurality of transactions according to a non-limiting embodiment;

FIG. 4 is a flow diagram of a method for anonymizing a plurality of transactions according to a non-limiting embodiment; and

FIG. 5 is a diagram of a one or more components, devices, and/or systems according to non-limiting embodiments.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “transaction service provider” may refer to an entity that receives transaction authorization requests from merchants or other entities and provides guarantees of payment, in some cases through an agreement between the transaction service provider and an issuer institution. The terms “transaction service provider” and “transaction provider system” may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

As used herein, the term “issuer institution” may refer to one or more entities, such as a bank, that provide accounts to customers for conducting payment transactions, such as initiating credit and/or debit payments. For example, an issuer institution may provide an account identifier, such as a primary account number (PAN), to a customer that uniquely identifies one or more accounts associated with that customer. The account identifier may be embodied on a physical financial instrument, such as a payment card, and/or may be electronic and used for electronic payments. The terms “issuer institution,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “acquirer institution” may refer to an entity licensed by the transaction service provider and approved by the transaction service provider to originate transactions using a portable financial device of the transaction service provider. The transactions may include original credit transactions (OCTs) and account funding transactions (AFTs). The acquirer institution may be authorized by the transaction service provider to originate transactions using a portable financial device of the transaction service provider. The acquirer institution may contract with a payment gateway to enable the facilitators to sponsor merchants. An acquirer institution may be a financial institution, such as a bank. The terms “acquirer institution,” “acquirer bank,” and “acquirer system” may also refer to one or more computer systems operated by or on behalf of an acquirer institution, such as a server computer executing one or more software applications.

As used herein, the term “account identifier” may include one or more PANs, tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes. An issuer institution may be associated with a bank identification number (BIN) or other unique identifier that uniquely identifies it among other issuer institutions.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “computing device” may refer to one or more electronic devices that include one or more processors and are configured to process data. A computing device may be a mobile device, such as a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. A computing device may be a desktop computer or other non-mobile computer. Furthermore, the term “computer” may refer to any computing device that includes components to receive, process, and/or output data, and in non-limiting embodiments may include a display, a processor, memory, an input device, and a network interface. An “interface” refers to a generated display, such as one or more graphical user interfaces (GUIs) with which a user may interact, either directly or indirectly (e.g., through a keyboard, mouse, touchscreen, etc.).

As used herein, the term “payment device” may refer to a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a mobile device executing an electronic wallet application, a PDA, a security card, an access card, a wireless terminal, and/or a transponder, as examples. The payment device may include volatile or non-volatile memory to store information, such as an account identifier or a name of the account holder.

In non-limiting embodiments, a system and method for anonymizing a plurality of transactions allows for users (e.g., payers) to make payments to other entities (e.g., payees) without revealing the identity of the payees to the issuer institutions associated with the payment devices of the payers. Through the use of a unique arrangement of user pools and thresholds, an anonymizing service, and anonymous payment tokens, a timing of a user requested transaction may be randomly modified to prevent others from inferring the identity of the payer and/or payee from timestamps and other contextual transaction data. Other advantages and benefits of non-limiting embodiments are described herein.

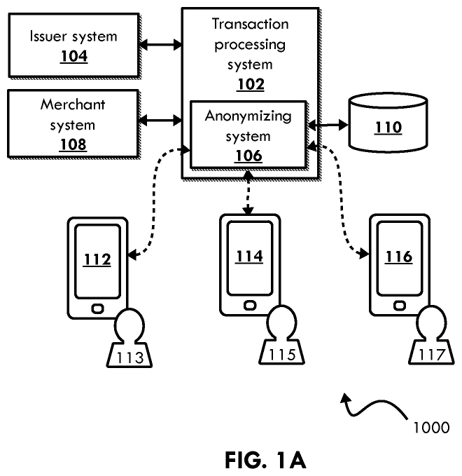

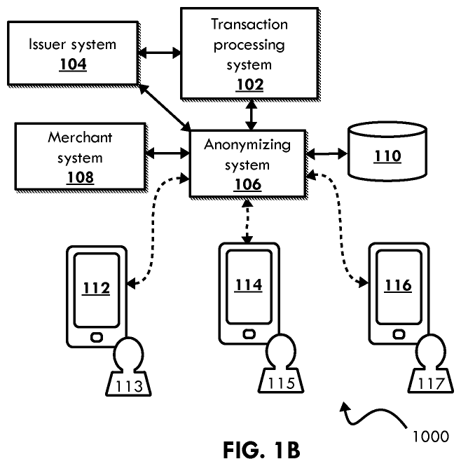

Referring now to FIGS. 1A and 1B, a system 1000 for anonymizing a plurality of transactions is shown according to non-limiting embodiments. A transaction processing system 102 is in communication with one or more issuer systems 104 and merchant systems 108. The transaction processing system 102 may also be in communication with, or include as part thereof, an anonymizing system 106. As pictured in FIG. 1A, the anonymizing system 106 is a subsystem of the transaction processing system 102. However, as shown in FIG. 1B, the anonymizing system 106 is external to the transaction processing system 102. It will be appreciated that various arrangements are possible. In non-limiting embodiments, the anonymizing system 106 includes hardware and/or software, such as one or more configured computing devices, programmed and/or configured to perform as described herein. The anonymizing system 106 is in communication with a plurality of payer user devices 112, 114, 116 associated with a respective plurality of payer users 113, 115, 117. The payer user devices 112, 114, 116 may be in communication with the anonymizing system 106 via one or more networks, such as the Internet, utilizing one or more software applications on the devices 112, 114, 116. Such software applications may include, for example, an electronic wallet application, a web browser, a third-party payment application, and/or the like.

With continued reference to FIGS. 1A and 1B, the anonymizing system 106 is also in communication with and/or includes an anonymous transaction database 110. In operation, the users 113, 115, 117 request to provide payments to one or more merchants or other entities using their respective user devices 112, 114, 116. For example, the user device 112 may generate a transaction request message identifying an account of the user 113 (e.g., a PAN or payment token), a transaction value (e.g., an amount to pay), and a payee identifier (e.g., a name of a payee, an account identifier of a payee, an email address of the payee, and/or the like). The anonymizing system 106 may then, either independently or through the transaction processing system 102 and/or a payment gateway, communicate an authorization request to the issuer system 104 that corresponds to the payment device of the payer associated with the user account. In non-limiting embodiments, the authorization request message communicated to the issuer system 104 does not identify the payee and is therefore independent of a payee identifier. The authorization request may identify the request as an anonymous transaction and/or may identify the anonymizing system 106 or related entity as the payee.

Still referring to FIGS. 1A and 1B, the issuer system 104 may either approve or deny the authorization request and communicate an authorization response to the anonymizing system 106 indicating such approval or denial. If the issuer system 104 denies the authorization request, such denial may be relayed and/or communicated to the user device 112. If the issuer system 104 approves the authorization request, the anonymizing system 106 may record the transaction in the anonymous transaction database 110 and allocate the transaction amount, either in full or after processing fees are applied, to an account associated with the payee, such as the merchant system 108. In some non-limiting embodiments, the anonymizing system 106 allocates the transaction amount to the payee by generating one or more anonymous payment tokens corresponding to the transaction amount. The anonymous payment tokens may then be redeemed by the payee through the anonymizing system 106 in various ways.

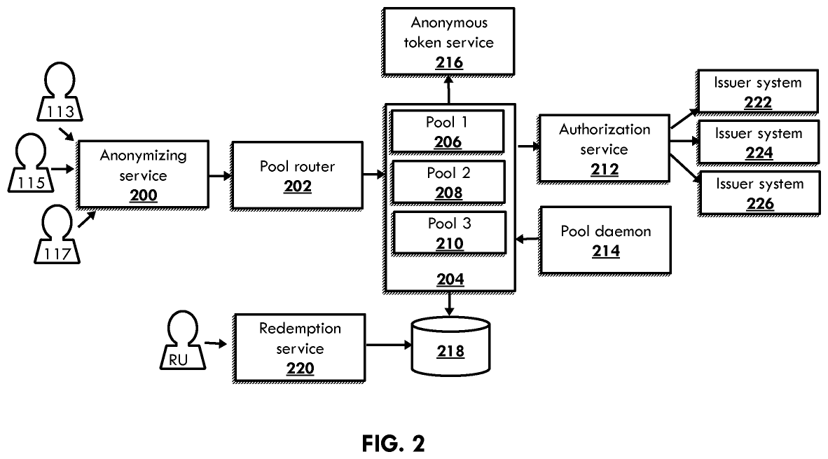

Referring now to FIG. 2, a system 2000 for anonymizing a plurality of transactions is shown according to non-limiting embodiments. A first user 113 may submit a request to the anonymizing service 200 that identifies an account of the user 113 (e.g., a PAN or payment token), a transaction value (e.g., an amount to pay), and a payee identifier (e.g., a name of a payee, an account identifier of a payee, an email address of a payee, and/or the like), as examples. The anonymizing service 200 may perform an anti-money laundering check and/or may process the user's request in any number of ways. In the non-limiting example shown in FIG. 2, the anonymizing service 200 may include any computing device and/or software application configured to receive requests from user devices and coordinate and/or initiate at least a portion of the method described herein.

With continued reference to FIG. 2, the anonymizing service 200 communicates payment data from the request to a pool router 202. In the non-limiting example shown in FIG. 2, the pool router 202 may include any computing device and/or software application configured to route the request, or data based on the request, to a pool from a collection of pools 204. The pool router 202 executes logic to determine the pool to route the request to. The pool may be determined randomly among the collection of pools 204, may be determined based on one or more optimization algorithms to evenly allocate requests to pools, may be determined based on an expiration date of a pool, and/or may be determined in any other manner. In some non-limiting examples, the pool router 202 may determine whether to create a new pool for the request or to utilize an existing pool for the request.

Still referring to FIG. 2, the system 2000 may include a pool daemon 214. A pool daemon 214 may include any computing device and/or software application configured to monitor the lifecycles and utilization of individual pools 206, 208, 210. The pool daemon 214, pool router 202, and/or the collection of pools 204 may determine whether to create a new pool or to utilize an existing pool 206, 208, 210 for each new payment request. The pool daemon 214 may base the determination on one or more parameters such as, for example, the current size (e.g., aggregate value or number of transactions) of the pool, an expiration date of the pool, and/or the like. The pool daemon 214 may also determine when a pool 206, 208, 210 is completed (e.g., full) and ready for disbursement. This determination may be based on the pool expiring on a specified or default expiration date, the pool reaching a maximum size, and/or other criteria. In non-limiting embodiments, the pool daemon 214 and/or another component of the system may create a pool by randomly selecting a pool size (e.g., aggregate value or number of transactions, as examples). The pool size may be generated with any type of random number generated, such as a pseudo-random number generator. Randomizing the pool size makes it more difficult for a party to detect a pattern to identify a payee or payer.

With continued reference to FIG. 2, in response to the pool daemon 214 determining that a pool is complete and ready for disbursement, the pool daemon or the collection of pools 204 may communicate a disbursement request to an anonymous token service 216, the collection of pools 204, the anonymizing service, a transaction service provider, a payment gateway, and/or the like. In non-limiting embodiments, the pool daemon 214 invokes the anonymous token service 216 in response to a pool being completed and the anonymous token service 216, when invoked, generates individual anonymous payment tokens to be stored in the payment ledger of a database 218 and provided to a payee. A pool may be completed in any amount of time, such as one or more milliseconds, seconds, minutes, and/or the like, based on the configuration of the pool daemon 214 and the number of transactions and pools.

Still referring to FIG. 2, the collection of pools 204 communicates with an authorization service 212 which, in turn, is in communication with a plurality of issuer systems 222, 224, 226. The pool selected for a particular payment request communicates with the issuer system corresponding to the payment device used to initiate the request, such as issuer system 222. The issuer system 222, in response, authorizes the transaction and communicates authorization data, such as an authorization response message, to the pool. The pool also communicates with an anonymous token service 216. The anonymous token service may include any computing device and/or software application configured to generate an anonymous token or other form of payment device that can be used by a payee to claim funds. For example, the anonymous token service may take, as input, a transaction value, an account token or other account identifier, and/or other transaction data, and output an anonymous token that does not identify the payer or the payment token. The anonymous token may be, for example, an alphanumeric value that corresponds to a value in a payment ledger stored in a database 218.

In the non-limiting example shown in FIG. 2, a redeeming user RU provided with the anonymous token is able to redeem the anonymous token or otherwise utilize the anonymous token with a redemption service 220. The redemption service 220 may include any computing device and/or software application configured to allow a payee to claim funds or otherwise receive a benefit from an anonymous token. The redemption service 220 is in communication with the database 218 including the payment ledger such that, in response to a redemption request from the requesting user RU that includes or identifies the anonymous token, the redemption service 220 queries the database to determine the validity of the anonymous token, the value of the anonymous token, any restrictions on the anonymous token (e.g., expiration date, time/date limitations, merchant category limitations, and/or the like), the ownership of the anonymous token (e.g., such that the redeeming user RU is determined to be authentic), and/or other like parameters. The redemption service 220 may be in communication with one or more transaction service providers, issuer systems, acquirer systems, payment gateways, merchant systems, and/or the like to effectuate the redemption. For example, after validating the anonymous token using the payment ledger, the redemption service 220 may communicate a request to a payment credit service that, in turn, invokes a payment routing service of a transaction service provider.

With continued reference to FIG. 2, each pool 206, 208, 210 in the collection of pools 204 may hold an aggregation of funds collected from different issuer systems 222, 224, 226 for providing payments anonymously from payers 113, 115, 117 to payees, such that the issuer system 222, 224, 226 associated with the payer cannot track or otherwise monitor the destination of the payment. It will be appreciated that an arrangement (not shown in FIG. 2) may be implemented in which different payees receive funds in a payment pool such that the funds are credited to their respective payment devices or accounts.

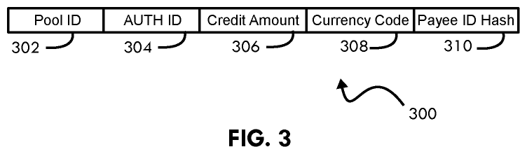

Referring now to FIG. 3, an anonymous payment token 300 is shown according to a non-limiting embodiment. The anonymous payment token 300 may be issued to a payee without identifying the payer, the issuer system associated with the payer, or other like identifying information. As shown in FIG. 3, the anonymous payment token 300 may include fields such as a pool identifier 302, authorization identifier 304, credit amount 306, currency code 308, and a payee identifier hash 310. It will be appreciated that an anonymous payment token 300 may include fewer or more fields than shown in FIG. 3, and that some fields may be stored in a separate database that is mapped to the anonymous payment token. For example, an anonymous payment token and/or mapped database field may include an expiration date, a restriction on use, and/or the like.

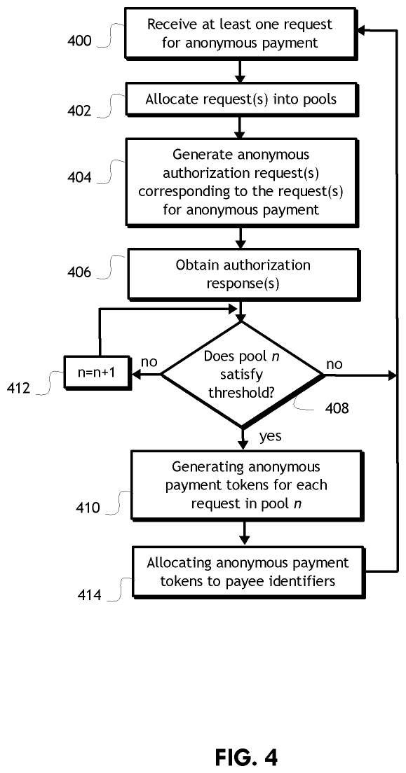

Referring now to FIG. 4, a flow diagram for a method of anonymizing a plurality of transactions is shown according to non-limiting embodiments. At step 400, at least one transaction request is received for making an anonymous payment to a payee. The request(s) may be received by an anonymizing service, as described herein. At step 402, each request received at step 400 is allocated into a pool of a collection of pools. The pool may be preexisting or created anew. The requests may be allocated in any number of ways, as described herein. For example, requests may be sequentially added to pools such that, when a first pool is completed, a second pool begins to be utilized.

With continued reference to FIG. 4, at step 404, an anonymous authorization request is generated for each of the transaction requests for making an anonymous payment. The anonymous authorization request identifies the payer and the payer's account identifier or account token, but does not identify the payee. Rather, the anonymous authorization requests identifies the anonymizing service or some other entity. At step 406, an authorization response is obtained for each of the anonymous authorization requests generated at step 404. An authorization response may be obtained, for example, by communicating an anonymous authorization request to an issuer system corresponding to the payment device used by the user. In some non-limiting embodiments, the anonymous authorization request may identify that the request is for an anonymizing service. In other non-limiting examples, however, the anonymous authorization request may be structured such that it appears to be a transaction with a typical payee, but where the identified payee is actually an anonymizing service and not the intended payee identified by the payer when initiating the transaction request.

Still referring to FIG. 4, at step 408, it is determined whether a pool satisfies a threshold. All pools may be analyzed at step 408 or, in other embodiments, the method proceeds to step 412 to increase the value of n and thereby iterate through each pool. A pool may satisfy a threshold by, for example, reaching a predetermined total aggregate value. If the pool does not satisfy the threshold, the method may either iterate through the pools at step 412 and/or proceed to step 400 to receive additional transaction requests for making anonymous payments. Once a pool satisfies a threshold, the method proceeds to step 410 at which an anonymous payment token is generated for each request in the pool. In this manner, the anonymous payment tokens are generated at a time subsequent to the request being made, where the time gap is based on the velocity of requests being received, the transaction values of the requests being received, the number of pools, the threshold, and/or other like parameters. The pool may be destroyed, reset, and/or the like. At step 414, the anonymous payment tokens are allocated to payee identifiers on a ledger such that they can be redeemed. The method then proceeds back to step 400.

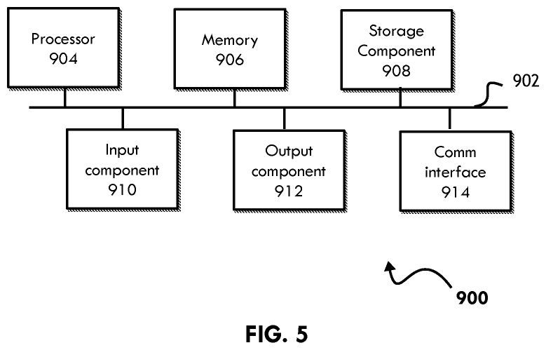

Referring now to FIG. 5, shown is a diagram of example components of a device 900 according to non-limiting embodiments. Device 900 may correspond to the anonymizing system 106, issuer system 104, merchant system 108, user device 112, 114, 116, and/or transaction processing system 102 shown in FIGS. 1A and 1B, and/or the anonymizing service 200, pool router 202, anonymous token service 216, pool daemon 214, authorization service 212, redemption service 220, and/or issuer system 222, 224, 226 in FIG. 2. In some non-limiting embodiments, such systems or devices may include at least one device 900 and/or at least one component of device 900. The number and arrangement of components shown in FIG. 5 are provided as an example. In some non-limiting embodiments, device 900 may include additional components, fewer components, different components, or differently arranged components than those shown in FIG. 5. Additionally, or alternatively, a set of components (e.g., one or more components) of device 900 may perform one or more functions described as being performed by another set of components of device 900.

As shown in FIG. 5, device 900 may include a bus 902, a processor 904, memory 906, a storage component 908, an input component 910, an output component 912, and a communication interface 914. Bus 902 may include a component that permits communication among the components of device 900. In some non-limiting embodiments, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 5, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

The invention claimed is:

1. A computer-implemented method for anonymizing a plurality of transactions, comprising:
receiving, with at least one processor, a plurality of transaction requests from a plurality of account holders, each transaction request comprising a payee identifier and a payer identifier;
generating, with at least one processor, a plurality of anonymous authorization requests corresponding to the plurality of transaction requests, wherein each anonymous authorization request is independent of the payee identifier of the corresponding transaction request;
communicating, with at least one processor, the plurality of anonymous authorization requests to at least one issuer system or a transaction processing system;
receiving, with at least one processor, a plurality of authorization responses corresponding to the plurality of anonymous authorization requests;
determining, with at least one processor, that a first plurality of transaction requests of the plurality of transaction requests satisfies a threshold;
in response to determining that the first plurality of transaction requests satisfies the threshold, generating, with at least one processor, a plurality of anonymous payment tokens, each anonymous payment token corresponding to an authorized transaction request of the first plurality of transaction requests; and
allocating, with at least one processor, each anonymous payment token to a corresponding payee identifier.

2. The computer-implemented method of claim 1, further comprising:
determining, with at least one processor, that a second plurality of authorized transaction requests of the plurality of transaction requests satisfies the threshold or a second threshold;
in response to determining that the second plurality of authorized transaction requests satisfies the threshold, generating, with at least one processor, a second plurality of anonymous payment tokens, each anonymous payment token corresponding to an authorized transaction request of the second plurality of authorized transaction requests; and
allocating, with at least one processor, each anonymous payment token to a corresponding payee identifier.

3. The computer-implemented method of claim 1, wherein the threshold comprises at least one of the following: a number of transactions, a number of accounts, an aggregate transaction value, or any combination thereof.

4. The computer-implemented method of claim 1, wherein the threshold comprises at least one of the following: a random value, a dynamic value, a predetermined value, or any combination thereof.

5. The computer-implemented method of claim 1, wherein the plurality of anonymous authorization requests correspond to the first plurality of transactions, and wherein the plurality of anonymous authorization requests are communicated to the at least one issuer system or transaction processing system in response to determining that the first plurality of transactions satisfies the threshold.

6. The computer-implemented method of claim 1, wherein the plurality of anonymous authorization requests correspond to the plurality of transactions, and wherein the plurality of anonymous authorization requests are communicated to the at least one issuer system or transaction processing system prior to determining that the first plurality of transactions satisfies the threshold.

7. The computer-implemented method of claim 1, further comprising:
for each transaction request of the plurality of transaction requests, determine a pool from a plurality of pools to allocate the transaction request, wherein the first plurality of transactions is allocated to a first pool; and
for each pool of the plurality of pools, adding transaction values for each transaction request in the pool to determine an aggregate pool transaction value,
wherein the threshold is satisfied when the aggregate pool transaction value meets or exceeds the threshold.

8. The computer-implemented method of claim 1, further comprising:
for each transaction request of the plurality of transaction requests, determine a pool from a plurality of pools to allocate the transaction request, wherein the first plurality of transactions is allocated to a first pool; and
for each pool of the plurality of pools, incrementing a counter for each transaction request in the pool to determine an aggregate number of transactions,
wherein the threshold is satisfied when the aggregate number of transactions meets or exceeds the threshold.

9. A computer program product for anonymizing a plurality of transactions, comprising at least one non-transitory computer-readable medium including program instructions that, when executed by at least one processor, cause the at least one processor to:
receive a plurality of transaction requests from a plurality of account holders, each transaction request comprising a payee identifier and a payer identifier;
generate a plurality of anonymous authorization requests corresponding to the plurality of transaction requests, wherein each anonymous authorization request is independent of the payee identifier of the corresponding transaction request;
communicate the plurality of anonymous authorization requests to at least one issuer system or a transaction processing system;
receive a plurality of authorization responses corresponding to the plurality of anonymous authorization requests;
determine that a first plurality of transaction requests of the plurality of transaction requests satisfies a threshold;
in response to determining that the first plurality of transaction requests satisfies the threshold, generate a plurality of anonymous payment tokens, each anonymous payment token corresponding to an authorized transaction request of the first plurality of transaction requests; and
allocate each anonymous payment token to a corresponding payee identifier.

10. The computer program product of claim 9, wherein the program instructions further cause the at least one processor to:
determine that a second plurality of authorized transaction requests of the plurality of transaction requests satisfies the threshold or a second threshold;
in response to determining that the second plurality of authorized transaction requests satisfies the threshold, generate a second plurality of anonymous payment tokens, each anonymous payment token corresponding to an authorized transaction request of the second plurality of authorized transaction requests; and
allocate each anonymous payment token to a corresponding payee identifier.

11. The computer program product of claim 9, wherein the threshold comprises at least one of the following: a number of transactions, a number of accounts, an aggregate transaction value, or any combination thereof.

12. The computer program product of claim 9, wherein the threshold comprises at least one of the following: a random value, a dynamic value, a predetermined value, or any combination thereof.

13. The computer program product of claim 9, wherein the plurality of anonymous authorization requests correspond to the first plurality of transactions, and wherein the plurality of anonymous authorization requests are communicated to the at least one issuer system or transaction processing system in response to determining that the first plurality of transactions satisfies the threshold.

14. The computer program product of claim 9, wherein the plurality of anonymous authorization requests correspond to the plurality of transactions, and wherein the plurality of anonymous authorization requests are communicated to the at least one issuer system or transaction processing system prior to determining that the first plurality of transactions satisfies the threshold.

15. The computer program product of claim 9, wherein the program instructions further cause the at least one processor to:
for each transaction request of the plurality of transaction requests, determine a pool from a plurality of pools to allocate the transaction request, wherein the first plurality of transactions is allocated to a first pool; and
for each pool of the plurality of pools, add transaction values for each transaction request in the pool to determine an aggregate pool transaction value,
wherein the threshold is satisfied when the aggregate pool transaction value meets or exceeds the threshold.

16. The computer program product of claim 9, wherein the program instructions further cause the at least one processor to:
for each transaction request of the plurality of transaction requests, determine a pool from a plurality of pools to allocate the transaction request, wherein the first plurality of transactions is allocated to a first pool; and
for each pool of the plurality of pools, increment a counter for each transaction request in the pool to determine an aggregate number of transactions,
wherein the threshold is satisfied when the aggregate number of transactions meets or exceeds the threshold.

17. A system for anonymizing a plurality of transactions, comprising:
at least one data storage device comprising a ledger for a plurality of payees; and
at least one processor programmed or configured to:
receive a plurality of transaction requests from a plurality of account holders, each transaction request comprising a payee identifier and a payer identifier;
generate a plurality of anonymous authorization requests corresponding to the plurality of transaction requests, wherein each anonymous authorization request is independent of the payee identifier of the corresponding transaction request;
communicate the plurality of anonymous authorization requests to at least one issuer system or a transaction processing system;
receive a plurality of authorization responses corresponding to the plurality of anonymous authorization requests;
determine that a first plurality of transaction requests of the plurality of transaction requests satisfies a threshold;
in response to determining that the first plurality of transaction requests satisfies the threshold, generate a plurality of anonymous payment tokens, each anonymous payment token corresponding to an authorized transaction request of the first plurality of transaction requests; and
allocate each anonymous payment token to a corresponding payee identifier.

18. The system of claim 17, wherein the at least one processor is further programmed or configured to:
determine that a second plurality of authorized transaction requests of the plurality of transaction requests satisfies the threshold or a second threshold;
in response to determining that the second plurality of authorized transaction requests satisfies the threshold, generate a second plurality of anonymous payment tokens, each anonymous payment token corresponding to an authorized transaction request of the second plurality of authorized transaction requests; and
allocate each anonymous payment token to a corresponding payee identifier.

19. The system of claim 17, wherein the threshold comprises at least one of the following: a number of transactions, a number of accounts, an aggregate transaction value, or any combination thereof.

20. The system of claim 17, wherein the threshold comprises at least one of the following: a random value, a dynamic value, a predetermined value, or any combination thereof.

21. The system of claim 17, wherein the plurality of anonymous authorization requests correspond to the first plurality of transactions, and wherein the plurality of anonymous authorization requests are communicated to the at least one issuer system or transaction processing system in response to determining that the first plurality of transactions satisfies the threshold.

22. The system of claim 17, wherein the plurality of anonymous authorization requests correspond to the plurality of transactions, and wherein the plurality of anonymous authorization requests are communicated to the at least one issuer system or transaction processing system prior to determining that the first plurality of transactions satisfies the threshold.

23. The system of claim 17, wherein the processor is further programmed or configured to:
for each transaction request of the plurality of transaction requests, determine a pool from a plurality of pools to allocate the transaction request, wherein the first plurality of transactions is allocated to a first pool; and
for each pool of the plurality of pools, add transaction values for each transaction request in the pool to determine an aggregate pool transaction value,
wherein the threshold is satisfied when the aggregate pool transaction value meets or exceeds the threshold.

24. The system of claim 17, wherein the processor is further programmed or configured to:
for each transaction request of the plurality of transaction requests, determine a pool from a plurality of pools to allocate the transaction request, wherein the first plurality of transactions is allocated to a first pool; and
for each pool of the plurality of pools, increment a counter for each transaction request in the pool to determine an aggregate number of transactions,
wherein the threshold is satisfied when the aggregate number of transactions meets or exceeds the threshold.
